(19) United States
(12) Patent Application Publication
(10) Pub. No.: US 2014/0105273 A1
(43) Pub. Date: Apr. 17, 2014

(54) Adaptive power management within media delivery system

(71) Applicant: BROADCOM CORPORATION, Irvine, CA (US)

(72) Inventors: Xuemin (Sherman) Chen, Rancho Santa Fe, CA (US); Raj (Narayan) Rajgopal, San Jose, CA (US)

(73) Assignee: BROADCOM CORPORATION, Irvine, CA (US)

(21) Appl. No.: 13/661,284

(22) Filed: Oct. 26, 2012

Related U.S. Application Data
(60) Provisional application No. 61/714,191, filed on Oct. 15, 2012.

(51) Int. Cl. H04N 7/26

(52) U.S. Cl. 375/240.02; 375/E07.126

(57) ABSTRACT

Adaptive power management within media delivery system. Power management is performed for one or more devices within a media or signal delivery system. Depending upon one or more local and/or remote considerations associated with one or more of the devices within the system, various processing operations may undergo appropriate provisioning among the respective devices. Considering devices that are battery-powered, certain processing operations that may be highly power or energy consumptive may be offloaded to other devices having sufficient power or energy to effectuate such operations or that are not so limited or constrained by power energy (e.g., being wall powered or non-battery-powered). Operation of one or more of the devices in compliance with a power or energy constraint may be directed by a power management application resident on one or more of the devices within the system.

### CROSS REFERENCE TO RELATED PATENTS/PATENT APPLICATIONS

### Provisional Priority Claims

The present U.S. Utility patent application claims priority pursuant to 35 U.S.C. §119(e) to the following U.S. Provisional Patent Application which is hereby incorporated herein by reference in its entirety and made part of the present U.S. Utility patent application for all purposes:

1. U.S. Provisional Patent Application Ser. No. 61/714,191, entitled “Adaptive power management within media delivery system,” (Attorney Docket No. BP30642), filed Oct. 15, 2012, pending.

### INCORPORATION BY REFERENCE

The following U.S. Utility patent application is hereby incorporated herein by reference in its entirety and made part of the present U.S. Utility patent application for all purposes:

1. U.S. Utility patent application Ser. No. 13/285,861, entitled “Streaming transcoder with adaptive upstream & downstream transcode coordination,” (Attorney Docket No. BP23224), filed Oct. 31, 2011, pending, which claims priority pursuant to 35 U.S.C. §119(e) to the following U.S. Provisional Patent Application which is hereby incorporated herein by reference in its entirety and made part of the present U.S. Utility patent application for all purposes:
1.1. U.S. Provisional Patent Application Ser. No. 61/541,938, entitled “Coding, communications, and signaling of video content within communication systems,” (Attorney Docket No. BP23215), filed Sep. 30, 2011, now expired.

The Utility patent application Ser. No. 13/285,861 (Attorney Docket No. BP23224) also claims priority pursuant to 35 U.S.C. §120, as a continuation-in-part (CIP), to the following U.S. Utility patent application which is hereby incorporated herein by reference in its entirety and made part of the present U.S. Utility patent application for all purposes:

2. U.S. Utility patent application Ser. No. 12/982,199, entitled “Transcoder supporting selective delivery of 2D, stereoscopic 3D, and multi-view 3D content from source video,” (Attorney Docket No. BP21239 or A05.01340000), filed Dec. 30, 2010, pending, which claims priority pursuant to 35 U.S.C. §119(e) to the following U.S. Provisional Patent Applications which are hereby incorporated herein by reference in their entirety and made part of the present U.S. Utility patent application for all purposes:
2.1. U.S. Provisional Patent Application Ser. No. 61/291,818, entitled “Adaptable image display,” (Attorney Docket No. BP21224 or A05.01200000), filed Dec. 31, 2009, now expired.
2.2. U.S. Provisional Patent Application Ser. No. 61/303,119, entitled “Adaptable image display,” (Attorney Docket No. BP21229 or A05.01250000), filed Feb. 10, 2010, now expired.

The Utility patent application Ser. No. 13/285,861 (Attorney Docket No. BP23224) also claims priority pursuant to 35 U.S.C. §120, as a continuation-in-part (CIP), to the following U.S. Utility patent application which is hereby incorporated herein by reference in its entirety and made part of the present U.S. Utility patent application for all purposes:

3. U.S. Utility patent application Ser. No. 12/982,330, entitled “Multi-path and multi-source 3D content storage, retrieval, and delivery,” (Attorney Docket No. BP21246 or A05.01410000), filed Dec. 30, 2010, pending, which claims priority pursuant to 35 U.S.C. §119(e) to the following U.S. Provisional Patent Applications which are hereby incorporated herein by reference in their entirety and made part of the present U.S. Utility patent application for all purposes:
3.1. U.S. Provisional Patent Application Ser. No. 61/291,818, entitled “Adaptable image display,” (Attorney Docket No. BP21224 or A05.01200000), filed Dec. 31, 2009, now expired.
3.2. U.S. Provisional Patent Application Ser. No. 61/303,119, entitled “Adaptable image display,” (Attorney Docket No. BP21229 or A05.01250000), filed Feb. 10, 2010, now expired.

The following U.S. Utility patent applications are hereby incorporated herein by reference in their entirety and made part of the present U.S. Utility patent application for all purposes:

1. U.S. Utility patent application Ser. No. 13/285,779, entitled “Entropy coder supporting selective employment of syntax and context adaptation,” (Attorney Docket No. BP23225), filed on Oct. 31, 2011, pending.

2. U.S. Utility patent application Ser. No. 13/285,644, entitled “Adaptive multi-standard video coder supporting adaptive standard selection and mid-stream switch-over,” (Attorney Docket No. BP23226), filed on Oct. 31, 2011, pending.

The following standards/draft standards are hereby incorporated herein by reference in their entirety and are made part of the present U.S. Utility patent application for all purposes:

1. “High efficiency video coding (HEVC) text specification draft 6,” Joint Collaborative Team on Video Coding (JCT-VC) of ITU-T SG16 WP3 and ISO/IEC JTC1/SC29/WG11, 7th Meeting: Geneva, CH, 21-30 November, 2011, Document: JCTVC-H1003, 259 pages.

2. International Telecommunication Union, ITU-T, TELECOMMUNICATION STANDARDIZATION SECTOR OF ITU, H.264 (March 2010), SERIES H: AUDIOVISUAL AND MULTIMEDIA SYSTEMS, Infrastructure of audiovisual services—Coding of moving video, Advanced video coding for generic audiovisual services, Recommendation ITU-T H.264, also alternatively referred to as International Telecomm ISO/IEC 14496-10—MPEG-4 Part 10, AVC (Advanced Video Coding), H.264/MPEG-4 Part 10 or AVC (Advanced Video Coding), ITU H.264/MPEG4-AVC, or equivalent.

### BACKGROUND OF THE INVENTION

1. Technical Field of the Invention

The invention relates generally to communication systems; and, more particularly, it relates to power management within such communication systems.

2. Description of Related Art

Data communication systems have been under continual development for many years. Various types of communication systems may include different respective devices, components, nodes, etc. Within such communication systems that may include a variety of different types of devices, certain users may access a variety of different components within such systems at different respective times. The present state-of-the-art does not provide a highly effective and efficient means by which operation and coordination among different respective devices may be made in a sufficiently acceptable manner.

### BRIEF DESCRIPTION OF THE SEVERAL VIEWS OF THE DRAWINGS

FIG. 1 and FIG. 2 illustrate various embodiments of communication systems.

FIG. 3 illustrates an embodiment of power management for communication devices implemented within a communication system.

FIG. 4 illustrates an embodiment of energy or power compliance for one or more communication devices.

FIG. 5 and FIG. 6 illustrate alternative embodiments of power management for communication devices implemented within a communication system.

FIG. 7 illustrates an embodiment of power management of one or more operational parameters for one or more communication device.

FIG. 8, FIG. 9A, FIG. 9B, FIG. 10A, and FIG. 10B illustrate various embodiments of methods for operating one or more communication devices.

### DETAILED DESCRIPTION OF THE INVENTION

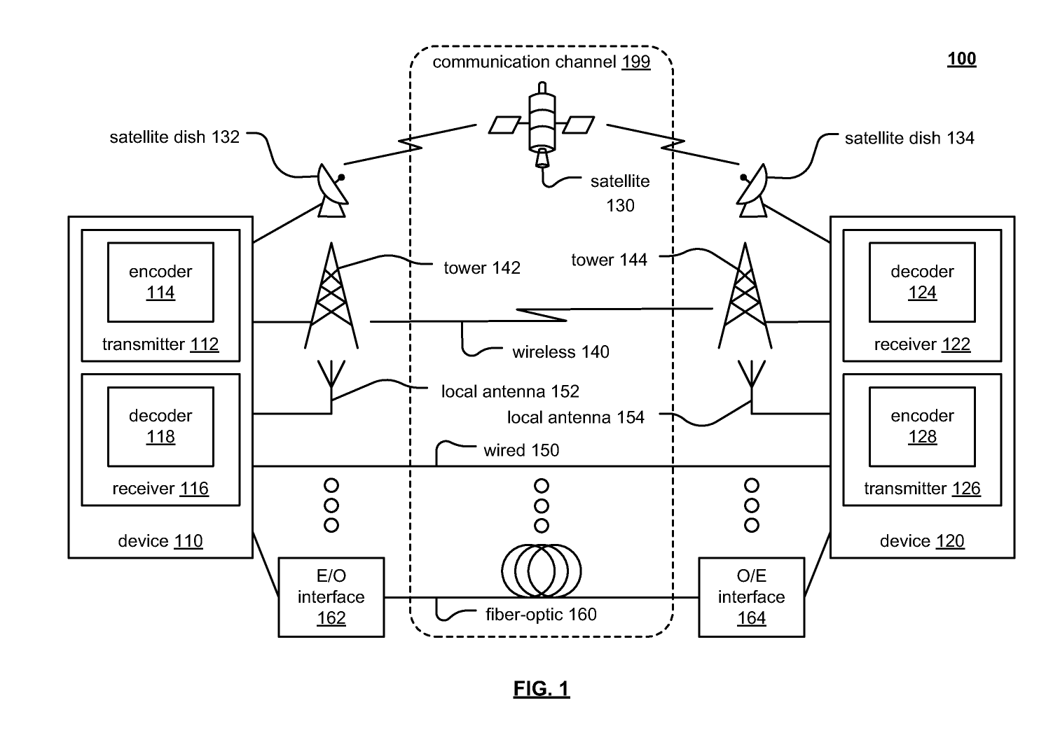

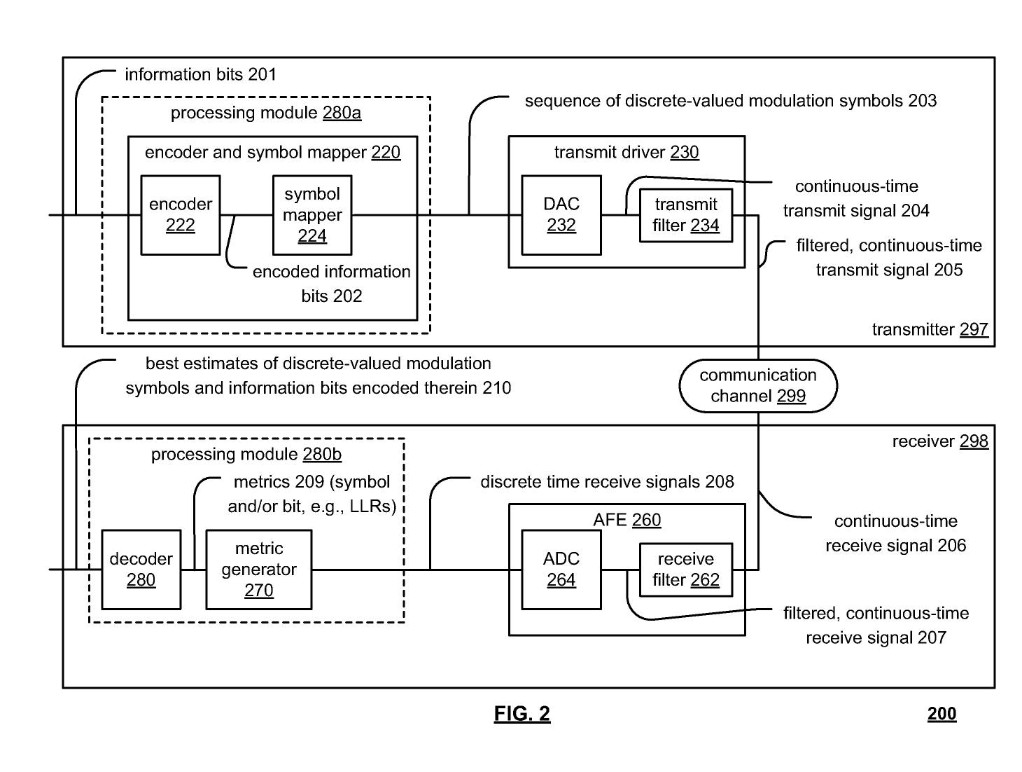

Within communication systems, signals are transmitted between various communication devices therein. The goal of digital communications systems is to transmit digital data from one location, or subsystem, to another either error free or with an acceptably low error rate. As shown in FIG. 1, data may be transmitted over a variety of communications channels in a wide variety of communication systems: magnetic media, wired, wireless, fiber, copper, and other types of media as well.

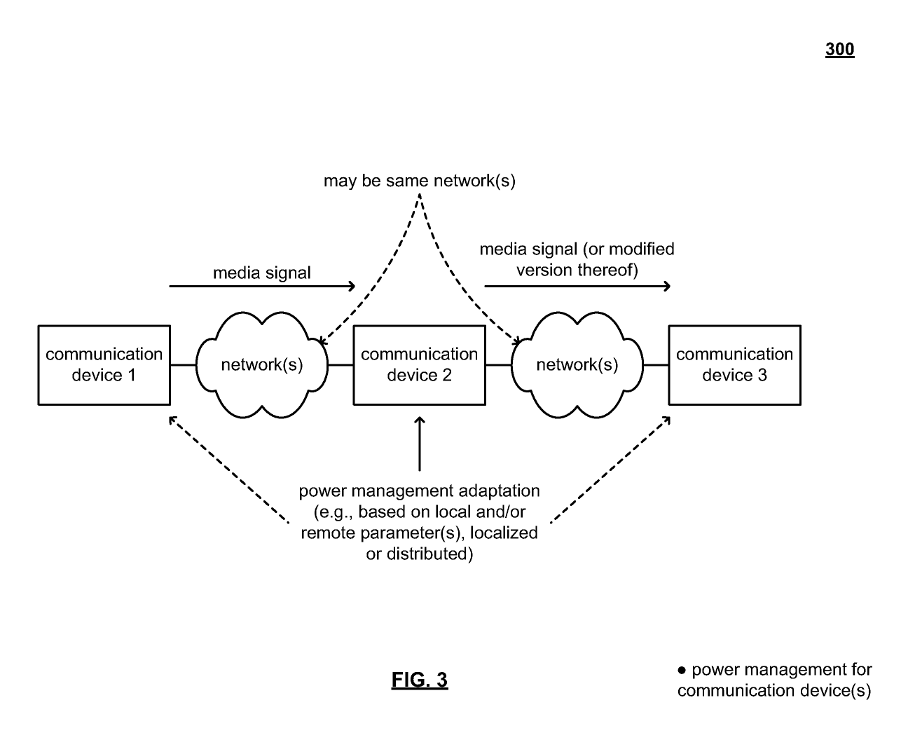

FIG. 1 and FIG. 2 illustrate various embodiments of communication systems, 100, and 200, respectively.

Referring to FIG. 1, this embodiment of a communication system 100 is a communication channel 199 that communicatively couples a communication device 110 (including a transmitter 112 having an encoder 114 and including a receiver 116 having a decoder 118) situated at one end of the communication channel 199 to another communication device 120 (including a transmitter 126 having an encoder 128 and including a receiver 122 having a decoder 124) at the other end of the communication channel 199. In some embodiments, either of the communication devices 110 and 120 may only include a transmitter or a receiver. There are several different types of media by which the communication channel 199 may be implemented (e.g., a satellite communication channel 130 using satellite dishes 132 and 134, a wireless communication channel 140 using towers 142 and 144 and/or local antennae 152 and 154, a wired communication channel 150, and/or a fiber-optic communication channel 160 using electrical to optical (E/O) interface 162 and optical to electrical (O/E) interface 164)). In addition, more than one type of media may be implemented and interfaced together thereby forming the communication channel 199.

It is noted that such communication devices 110 and/or 120 may be stationary or mobile without departing from the scope and spirit of the invention. For example, either one or both of the communication devices 110 and 120 may be implemented in a fixed location or may be a mobile communication device with capability to associate with and/or communicate with more than one network access point (e.g., different respective access points (APs) in the context of a mobile communication system including one or more wireless local area networks (WLANs), different respective satellites in the context of a mobile communication system including one or more satellite, or generally, different respective network access points in the context of a mobile communication system including one or more network access points by which communications may be effectuated with communication devices 110 and/or 120.

To reduce transmission errors that may undesirably be incurred within a communication system, error correction and channel coding schemes are often employed. Generally, these error correction and channel coding schemes involve the use of an encoder at the transmitter end of the communication channel 199 and a decoder at the receiver end of the communication channel 199.

Any of various types of ECC codes described can be employed within any such desired communication system (e.g., including those variations described with respect to FIG. 1), any information storage device (e.g., hard disk drives (HDDs), network information storage devices and/or servers, etc.) or any application in which information encoding and/or decoding is desired.

Generally speaking, when considering a communication system in which video data is communicated from one location, or subsystem, to another, video data encoding may generally be viewed as being performed at a transmitting end of the communication channel 199, and video data decoding may generally be viewed as being performed at a receiving end of the communication channel 199.

Also, while the embodiment of this diagram shows bi-directional communication being capable between the communication devices 110 and 120, it is of course noted that, in some embodiments, the communication device 110 may include only video data encoding capability, and the communication device 120 may include only video data decoding capability, or vice versa (e.g., in a uni-directional communication embodiment such as in accordance with a video broadcast embodiment).

Referring to the communication system 200 of FIG. 2, at a transmitting end of a communication channel 299, information bits 201 (e.g., corresponding particularly to video data in one embodiment) are provided to a transmitter 297 that is operable to perform encoding of these information bits 201 using an encoder and symbol mapper 220 (which may be viewed as being distinct functional blocks 222 and 224, respectively) thereby generating a sequence of discrete-valued modulation symbols 203 that is provided to a transmit driver 230 that uses a DAC (Digital to Analog Converter) 232 to generate a continuous-time transmit signal 204 and a transmit filter 234 to generate a filtered, continuous-time transmit signal 205 that substantially comports with the communication channel 299. At a receiving end of the communication channel 299, continuous-time receive signal 206 is provided to an AFE (Analog Front End) 260 that includes a receive filter 262 (that generates a filtered, continuous-time receive signal 207) and an ADC (Analog to Digital Converter) 264 (that generates discrete-time receive signals 208). A metric generator 270 calculates metrics 209 (e.g., on either a symbol and/or bit basis) that are employed by a decoder 280 to make best estimates of the discrete-valued modulation symbols and information bits encoded therein 210.

Within each of the transmitter 297 and the receiver 298, any desired integration of various components, blocks, functional blocks, circuitries, etc. Therein may be implemented. For example, this diagram shows a processing module 280a as including the encoder and symbol mapper 220 and all associated, corresponding components therein, and a processing module 280 is shown as including the metric generator 270 and the decoder 280 and all associated, corresponding components therein. Such processing modules 280a and 280b may be respective integrated circuits. Of course, other boundaries and groupings may alternatively be performed without departing from the scope and spirit of the invention. For example, all components within the transmitter 297 may be included within a first processing module or integrated circuit, and all components within the receiver 298 may be included within a second processing module or integrated circuit. Alternatively, any other combination of components within each of the transmitter 297 and the receiver 298 may be made in other embodiments.

As with the previous embodiment, such a communication system 200 may be employed for the communication of video data is communicated from one location, or subsystem, to another (e.g., from transmitter 297 to the receiver 298 via the communication channel 299).

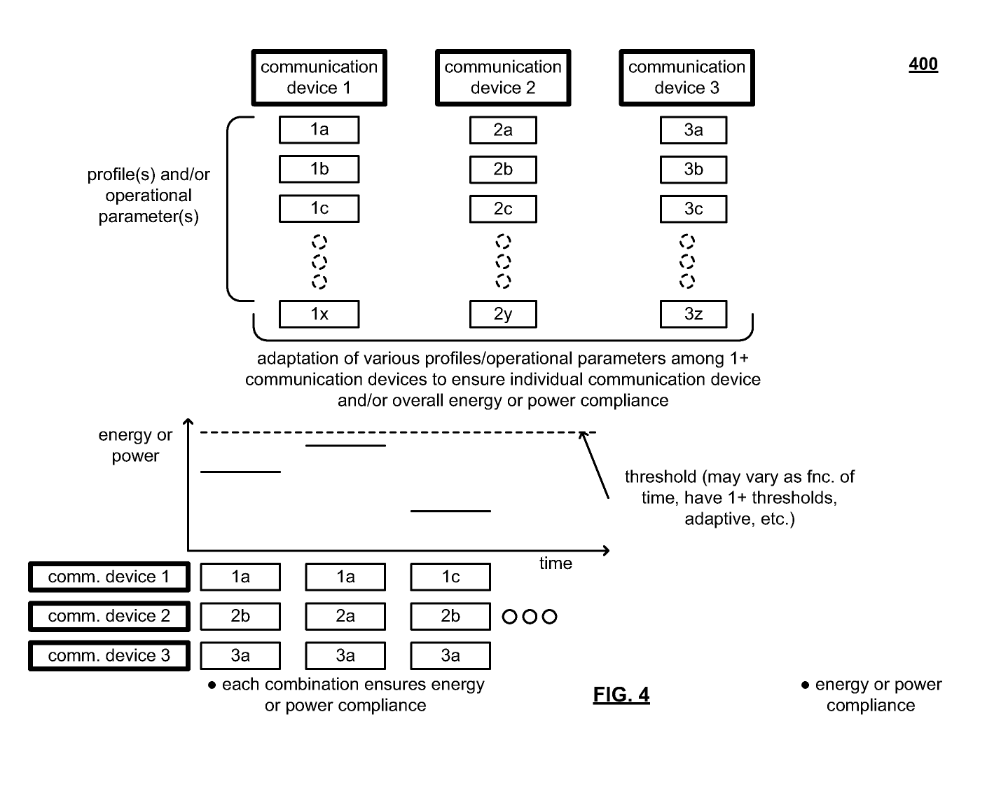

FIG. 3 illustrates an embodiment 300 of power management for communication devices implemented within a communication system. A number of different respective communication devices may be implemented within a communication system, and those respective communication devices may be operative to communicate there between via one or more respective mitigation networks. A first communication device may provide a media signal to a second communication device via one or more networks, communication links, etc., and that second communication device may provide that media signal, or a modified version thereof, to a third communication device via those one or more networks, communication links, etc. for one or more other networks, communication links, etc.).

At least one of the communication devices operates to perform power management adaptation. For example, in the context of media signaling, such power management may be operative for performing adaptive scalable encoding or transcoding in accordance with a number of different operational modes of one or more of the communication devices. For example, at least one configuration of the one or more communication networks or at least one operational parameter corresponding to the communication system (e.g., corresponding to any one or more of the communication devices therein, communication links, etc.) may be a consideration for operating the communication system to ensure compliance with at least one power or energy operational constraint. In certain instances, such compliance corresponds to operation in accordance with an efficiency related power or energy recommended practice or standard (e.g., Energy-Efficient Ethernet, GreenPower, any version of ENERGY STAR, 80 PLUS, Climate Savers Computing Initiative, The Green Grid, etc. and/or any such recommended practice or standard directed towards power or energy efficiency of any one or more devices within such a system, the overall operation of the system, etc.). In certain alternative embodiments, such a power or energy operational constraint may be proprietary or user defined for the given application, without necessarily complying with efficiency related power or energy recommended practice or standard per se (e.g., such as a power or energy operational constraint that is user-defined).

Generally speaking, such power management adaptation may be performed for any one or more of the respective communication devices within the system based upon any one or more local and/or remote parameters. In addition, it is noted that such a power management application may be resident on any one of the communication devices within the system. Such power management may be applied not only to a given device on which that particular application is resident, but the power management may be directed towards controlling operation of another of the communication devices within the system as well. In an alternative embodiment, such a power management application may be provisioned in a distributed manner, such that different respective portions of the application are resident on more than one respective communication device, and those different respective portions of the application operate cooperatively with one another. Of course, it is also noted that not all of the respective portions of the application need necessarily be operative at any given time, such that different respective portions of the application, when implemented in a distributed manner across different respective devices, may be operative at different respective times. Generally speaking, such power management, regardless of the particular manner in which such an application is implemented across one or more devices, may allow for coordination and cooperation of different respective devices within the system to ensure compliance with at least one power or energy operational constraint for one or more of the respective devices within the overall system or for the overall system itself.

In accordance with operation of the communication system, adaptation of operation of one or more of the communication devices within the system may be made to ensure that one or more of the devices or the entire system itself operates in compliance with at least one power or energy operational constraint. Considering the application of delivery of media signals (e.g., video, audio, etc.), certain characteristics of those media signals may be adapted in proportion to the amount of energy or power a given device uses. Particularly in the context of battery-powered devices within the system (e.g., handheld type devices, mobile phones, smart phones, personal digital assistants, tablets, had type devices, etc.), as such battery-powered devices are idle, a significant amount of power or energy may be dissipated. Appropriate management of the energy employed by one or more of the devices may be made by the power management capability implemented within the one or more of the respective devices in the system.

Particularly considering an embodiment delivering video signals, different respective parameters (e.g., resolution, frame rate, aspect ratio, frames per second, other scalable video coding (SVC) related parameters, etc.) may be controlled via such power management capability. In accordance with such a video delivery type system, such adaptation may operate by adapting or reconfiguring a number of respective nodes within the system. For example, such adaptation and reconfiguration may be directed towards various and code/decode/transcode pathway elements. Cited adaptation may be directed towards full on hardware acceleration to lower quality software instanced element transitions, etc. to accommodate local or remote power or energy resources. For example, consideration may be made with respect to local or downstream low battery resource conditions. Again, as may be understood with respect to battery-powered devices, energy or power conservation can provide for an improved user experience. In accordance with such power management capability, an application may employ information pertaining to local operating conditions (e.g., an amount of energy remaining in the area power device) to determine an appropriate option for processing the media signal (e.g., in accordance with adaptive scalable encoding or transcoding of the media signal such as in accordance with SVC). Such adaptation in terms of modifying the operation of one or more of the devices within the system may be made in real time, on-the-fly, etc. based upon consideration of one or more local and/or remote considerations. In addition, such adaptation may be made based upon predicted or anticipated future local and/or remote considerations, historical and prior local and/or remote considerations, etc.

In at least one possible embodiment including a number of respective devices, such power management capability may be implemented within a middling device therein. Such power management maybe we directed towards operation of that middling device itself and/or one or more source devices that provides one or more signals to the middling device and/or one or more destination devices that receive such one or more signals or processed or modified versions of one or more signals.

As may be understood, such power or energy optimization may be performed to ensure appropriate processing by those devices that have the capability to perform certain operations. For example, certain media or signal processing operations may be relatively more consumptive of power or energy by a given device. If one of the devices within the system in a relatively low on power (e.g., battery powered device having relatively low remaining energy stored therein), then that particular device may opt not to perform certain power or energy consumptive tasks, but instead provide the media or signal to another device to perform those power or energy consumptive operations. For example, a battery-powered device may offload certain processing operations to a wall powered device (e.g., such as a set-top box, a router, etc.). The wall powered device will not be so constrained in terms of power energy to effectuate such operations. It is noted that any number of considerations may be made to determine whether or not to offload such operations two different respective devices within the system. For example, when a given device is at full power state or has a fully charged battery, or has access to wall power, there may be a relative preference not to offload such operations which may be performed locally. However, when a given device is a relatively lower power state, or does not have access to wall power, then there may be a relative greater preference to offload such operations to be performed by one or more other devices within the system.

Other possible considerations may be employed for the directed selection of resources among the overall system. For example, depending upon the particular time of day (e.g., morning versus afternoon versus evening versus late evening, etc.), then adaptation may be made to ensure relatively higher characteristics (e.g., relatively higher or highest resolution, high definition, etc.) of media signals during one or more particular times then at others during which relatively lower characteristics (e.g., relatively lower or lower resolution, standard definition, etc.) is provided. In addition, consideration may be made based upon the number of devices, such as destination devices or clients, to which signals are to be provided, the respective capability of the various devices within the system (e.g., source devices and/or destination devices), an optimized configuration within the communication system for content delivery, etc.

As may be understood, adaptation of the operation of one or more of the respective devices within the system may be made based upon the availability of energy or power within one or more of those respective devices. Real-time, on-the-fly adaptation of the respective processes performed within the system to effectuate signal or media delivery (e.g., encode/decode/transcode) may be made to ensure a best or acceptable performance of the overall system.

Generally speaking, management of the respective resources within the system operative to effectuate delivery of signals or media may be made based upon information related to power or energy of those respective devices within the system. For example, devices within the system for the overall system may operate in accordance with a number of different respective operational modes. Certain operational modes may correspond to only subsets [i.e., less than all] of the respective devices within the system (e.g., sometimes including only one of the devices and system). In some instances, as few as one of the respective devices within the system is driven to operate in compliance with at least one power or energy operational constraint. In other instances, more than one, but less than all, of the respective devices within the system are driven to operate in compliance with at least one power or energy operational constraint. An even other instances, all of the respective devices within the system are driven to operate in compliance with at least one power or energy operational constraint.

As may be understood with respect to different respective operational modes, certain of the devices within the system may operate at full power while others do not, yet the overall system does operate in compliance with at least one power or energy operational constraint. There may be alternative certain instances in which all of the devices individually operate in compliance with at least one power or energy operational constraint.

With respect to consideration of local and/or remote operating conditions used to make decisions in regard to such power management, some considerations may be related to non-electrical system considerations per se. For example, with respect to delivery of media and its output via one or more output devices for consumption by one or more users, such environmental feedback (e.g., such as detecting a number of users who are consuming the media, such as may be made via a camera on a device performing identification of one or more users) may be one of the considerations employed by the power management. For example, if a relatively larger number of users is consuming the media, then one or more characteristics associated with the playback of the media may be increased, while if a relatively fewer number of users is consuming the media, then one or more characteristics associated with the playback of the media may be decreased.

It is also noted that such consideration of any one or more local and/or remote considerations may be updated or modified over time. That is to say, adaptation based upon such one or more local and/or remote considerations may vary over time such that any given consideration may have a relatively higher weight at one time and a relatively lower weight at another time. In addition, different respective considerations may be employed at different respective times (e.g., a first one or more considerations employed for power management at a first time, a second one or more considerations employed at a second time, etc.).

As may be understood with respect to this diagram including three different communication devices, power management adaptation may be made with respect to the operations of any one or more of these respective communication devices based upon any one or more local and/or remote parameters. Compliance of any one or more of these devices with a power or energy operational constraint, including any desired power or energy recommended practice or standard, may be made in accordance with adaptive scalable encoding, transcoding, and/or decoding operations to be performed within the system by any one or more of the devices. Different respective operational modes may be employed to ensure compliance with one or more power or energy operational constraints by one or more of the devices therein. With the one or more communication networks associated with this diagram as well as others herein, it is noted that any desired type of communication system, or combination thereof, may form any given network, including those described with reference to FIG. 1.

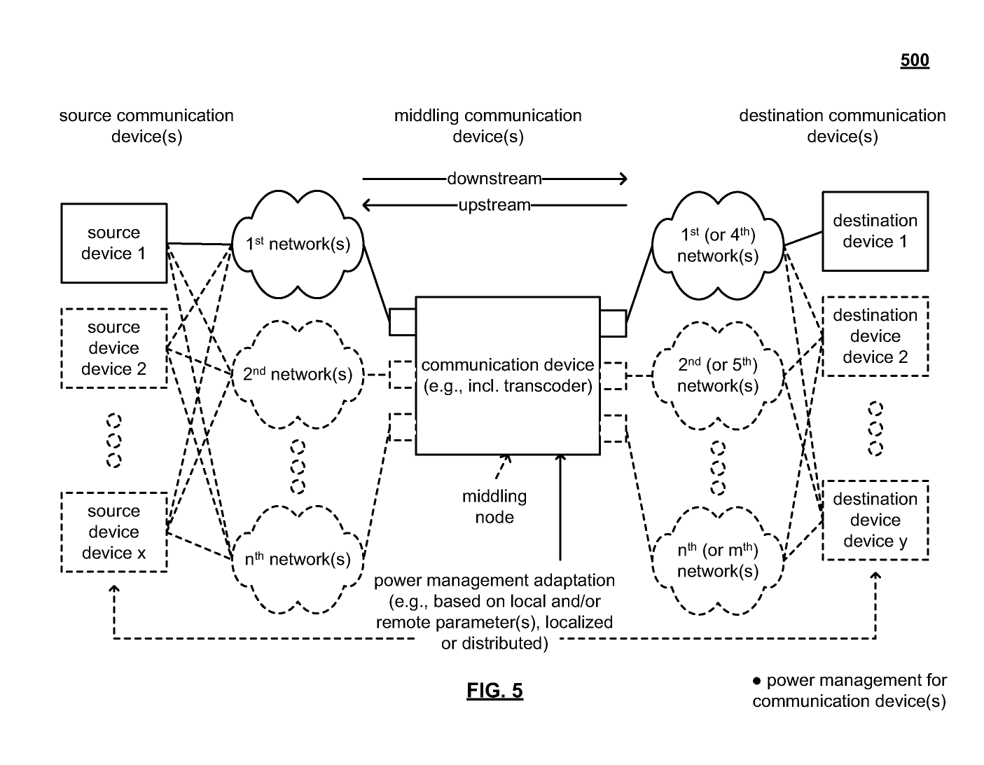

FIG. 4 illustrates an embodiment 400 of energy or power compliance for one or more communication devices. As may be understood with respect to this diagram, any given communication device may operate in accordance with one or more operational modes. Such operational modes may be characterized by one or more operational parameters, one or more profiles (e.g., such that each respective profile corresponding to different respective combinations of such operational parameters), etc.

A given power or energy operational constraint may be implemented as a threshold. Operation of different respective communication devices may individually or collaboratively undergo power management so as to ensure operation in compliance with that power or energy operational constraint. For example, considering the prior diagram including three respective communication devices, operation of the respective communication devices may cooperatively undergo power management to ensure that they all comply with the power or energy operational constraint.

For example, while the operation of each individual device may vary as a function of time, in that, different respective parameters, profiles, etc. may be employed a different respective times, the cooperative operation of the three respective devices still comply with the power or energy operational constraint (e.g., being relatively lower than a threshold associated with the power energy operational constraint).

Such functionality may alternatively be directed towards any one individual of the devices as well. For example, while different respective parameters, profiles, etc. may be employed by a given device at different respective times, operation of that given device may undergo power management to ensure that it does comply with a power or energy operational constraint.

In addition, it is noted that a given static or constant threshold associated with the power energy operational constraint need not necessarily be employed. For example, a threshold may be modified as a function of time. Alternatively, different respective thresholds may be employed at different respective times (e.g., a first threshold during the first period of time, second threshold at a second period of time, etc.). Also, it is noted that adaptation of the various profiles, operational parameters, etc. of the one or more communication devices may be made to ensure compliance of any one or more of the devices or the overall system.

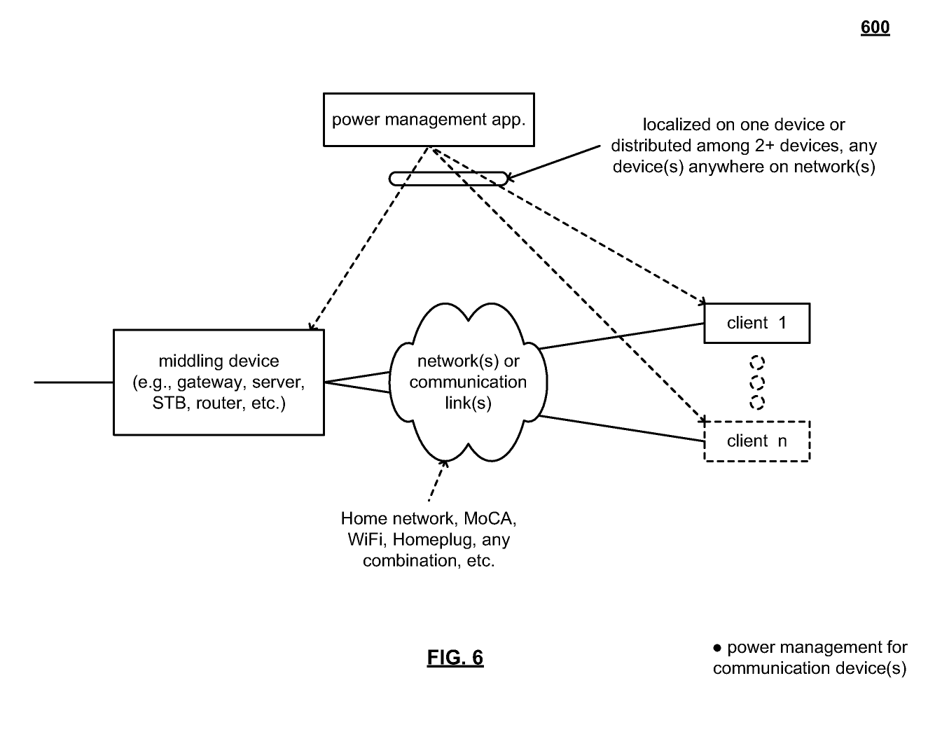

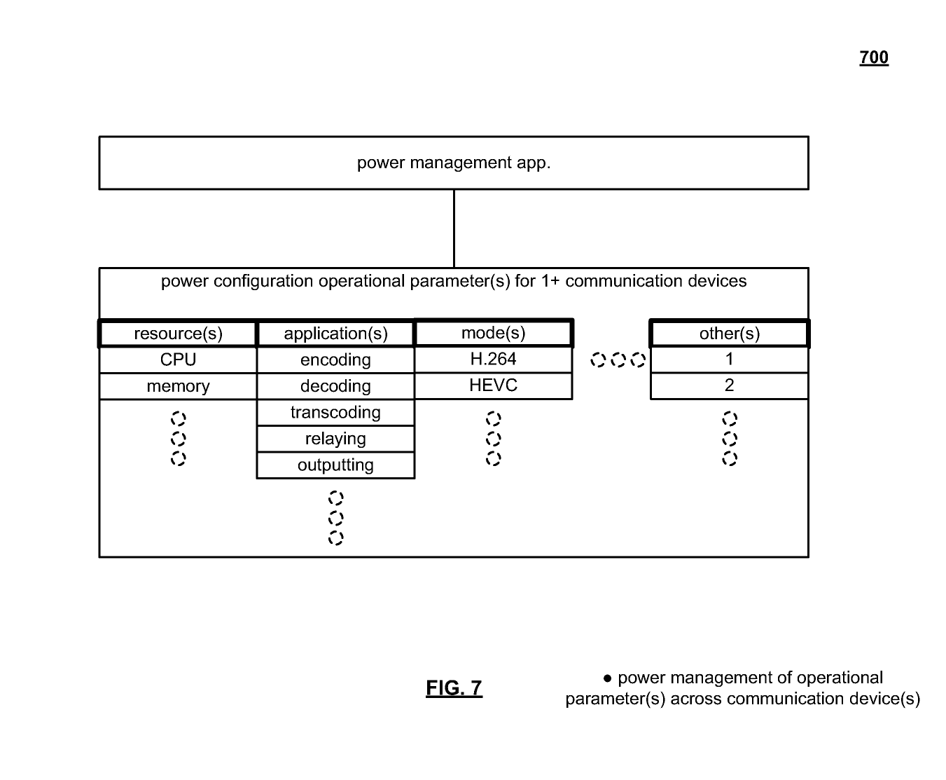

FIG. 5 and FIG. 6 illustrate alternative embodiments 500 and 600, respectively, of power management for communication devices implemented within a communication system.

Referring to the embodiment 500 of FIG. 5, FIG. 5 includes a middling communication device including a transcoder implemented within a communication system. As may be seen with respect to this diagram, a middling communication device including a transcoder may be implemented within a communication system composed of one or more networks, one or more source devices, and/or one or more destination devices. Generally speaking, such a transcoder may be viewed as being a middling device interveningly implemented between at least one source device and at least one destination device as connected and/or coupled via one or more communication links, networks, etc. In certain situations, such a transcoder may be implemented to include multiple inputs and/or multiple outputs for receiving and/or transmitting different respective signals from and/or to one or more other devices.

Operation of any one or more modules, circuitries, processes, steps, etc. within the transcoder may be adaptively made based upon consideration associated with local operational parameters and/or remote operational parameters. Examples of local operational parameters may be viewed as corresponding to provision and/or currently available hardware, processing resources, memory, etc. Examples of remote operational parameters may be viewed as corresponding to characteristics associated with respective streaming media flows, including delivery flows and/or source flows, corresponding to signaling which is received from and/or transmitted to one or more other devices, including source devices and/or destination devices. For example, characteristics associated with any media flow may be related to any one or more of latency, delay, noise, distortion, crosstalk, attenuation, signal to noise ratio (SNR), capacity, bandwidth, frequency spectrum, bit rate, symbol rate associated with the at least one streaming media source flow, and/or any other characteristic, etc. Considering another example, characteristics associated with any media flow may be related more particularly to a given device from which or through which such a media flow may pass including any one or more of user usage information, processing history, queuing, an energy constraint, a display size, a display resolution, a display history associated with the device, and/or any other characteristic, etc. Moreover, various signaling may be provided between respective devices in addition to signaling of media flows. That is to say, various feedback or control signals may be provided between respective devices within such a communication system.

In at least one embodiment, such a transcoder is implemented for selectively transcoding at least one streaming media source flow thereby generating at least one transcoded streaming media delivery flow based upon one or more characteristics associated with the at least one streaming media source flow and/or the at least one transcoder that streaming media delivery flow. That is to say, consideration may be performed by considering characteristics associated with flows with respect to an upstream perspective, a downstream perspective, and/or both an upstream and downstream perspective. Based upon these characteristics, including historical information related thereto, current information related thereto, and/or predicted future information related thereto, adaptation of the respective transcoding as performed within the transcoder may be made. Again, consideration may also be made with respect to global operating conditions and/or the current status of operations being performed within the transcoder itself. That is to say, consideration with respect to local operating conditions (e.g., available processing resources, available memory, source flow(s) being received, delivery flow(s) being transmitted, etc.) may also be used to effectuate adaptation of respective transcoding as performed within the transcoder.

In certain embodiments, adaptation is performed by selecting one particular video coding protocol or standard from among a number of available video coding protocols or standards. If desired, such adaptation may be with respect to selecting one particular profile of a given video coding protocol or standard from among a number of available profiles corresponding to one or more video coding protocols or standards. Alternatively, such adaptation may be made with respect to modifying one or more operational parameters associated with a video coding protocol or standard, a profile thereof, or a subset of operational parameters associated with the video coding protocol or standard.

In other embodiments, adaptation is performed by selecting different respective manners by which video coding may be performed. That is to say, certain video coding, particularly operative in accordance with entropy coding, may be context adaptive, non-context adaptive, operative in accordance with syntax, or operative in accordance with no syntax. Adaptive selection between such operational modes, specifically between context adaptive and non-context adaptive, and with or without syntax, may be made based upon such considerations as described herein.

Generally speaking, a real time transcoding environment may be implemented wherein scalable video coding (SVC) operates both upstream and downstream of the transcoder and wherein the transcoder acts to coordinate upstream SVC with downstream SVC. Such coordination involves both internal sharing real time awareness of activities wholly within each of the transcoding decoder and transcoding encoder. This awareness extends to external knowledge gleaned by the transcoding encoder and decoder when evaluating their respective communication physical layer (PHY)/channel performance. Further, such awareness exchange extends to actual feedback received from a downstream media presentation device's decoder and PHY, as well as an upstream media source encoder and PHY. To fully carry out SVC plus overall flow management, control signaling via industry or proprietary standard channels flow between all three nodes.

As may be understood with respect to this diagram, power management adaptation may be effectuated by any one or more or among all of the respective devices within such a system, including source devices, middling devices, destination devices, etc. Appropriate coordination of the operations performed by the respective devices may be made to ensure compliance with a power or energy operational constraints for any one or more of those devices or all of the devices.

Referring to the embodiment 600 of FIG. 6, FIG. 6 shows power management being effectuated based upon various characteristics such as the type of network or communication link via which signaling is provided (e.g., a wireless network, home network, a multimedia over coax alliance (MoCA®, or generally referred to as MoCA) network, a Wi-Fi network, Homeplug or power-line based system, etc.) to one or more destination devices or clients. Such a power management application may be implemented on the middling device (e.g., a gateway, server, set top box, a router, a Wi-Fi hotspot, etc. or generally any intervening middling device within a given communication system). In alternative embodiments, such power management capability and operations may be performed cooperatively by more than one respective device in the system. In addition, it is noted that such power management capability and operations may be performed by a first device in the system during a first time, by a second device in the system during the second time, etc.

Generally speaking, such power management may be performed based upon various device capabilities, available resources, historical availability of resources or performance, future or anticipated availability of resources or performance, etc. to adapt operation of one or more of those respective devices within the system to effectuate delivery of signaling or media therein.

FIG. 7 illustrates an embodiment 700 of power management of one or more operational parameters for one or more communication device. This diagram shows how various operational parameters associated with one or more communication devices may be employed to effectuate power management across one or more of the communication devices within the system. For example, actual resources of any one or more given devices (e.g., CPU capability, provisioned memory, etc.), the actual applications to be performed by any given device (e.g., encoding, decoding, transcoding, relaying, outputting, etc.), The particular operational modes in which a given device is to operate (e.g., considering video encoding, operating in accordance with a given video coding recommended practice or standards such as H.264, high efficiency video coding (HEVC), etc.), and/or any other local and/or remote operational parameter may be employed as an input to power management operations.

In addition, it is noted that different respective operational parameters may be employed at different respective times as inputs and consideration for such power management application. Also, these respective operational parameters may be relatively weighted more or less at different respective times based upon any of a number of considerations (e.g., current operational conditions, environmental conditions, etc.). Generally, this diagram shows how any of a number of different categories of operational parameters and any of a number of respective operational parameters within those categories may be employed to serve as input to power management operations.

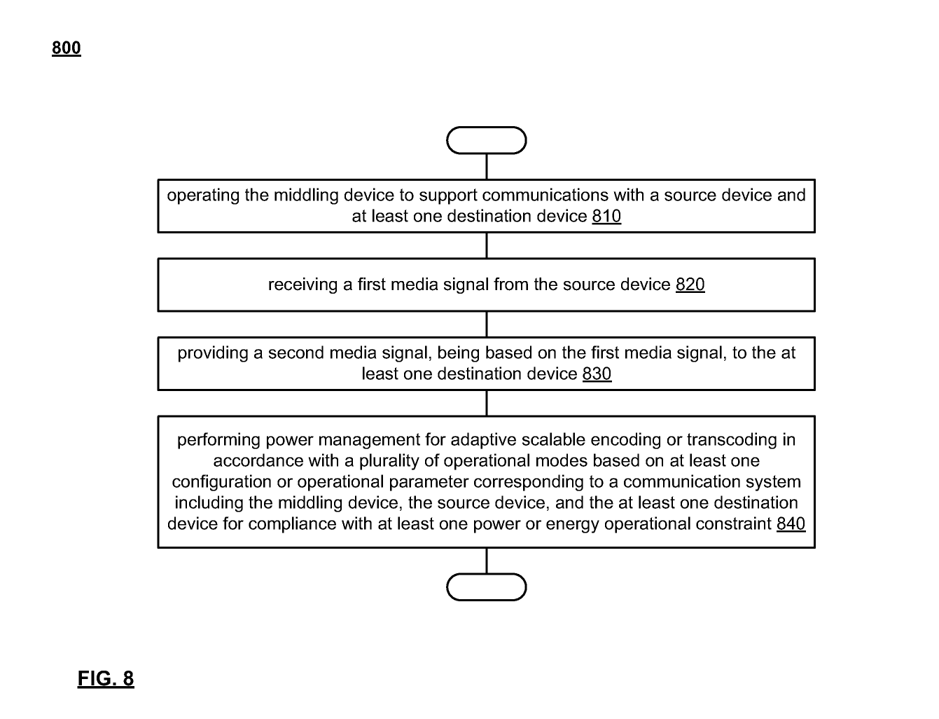

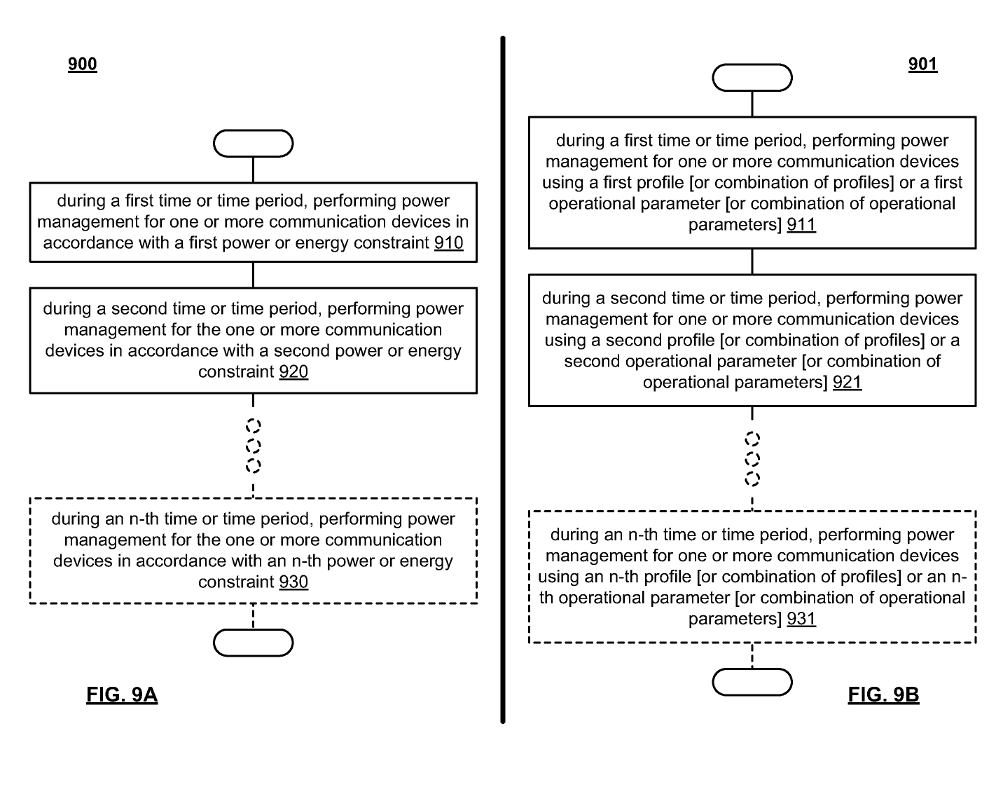

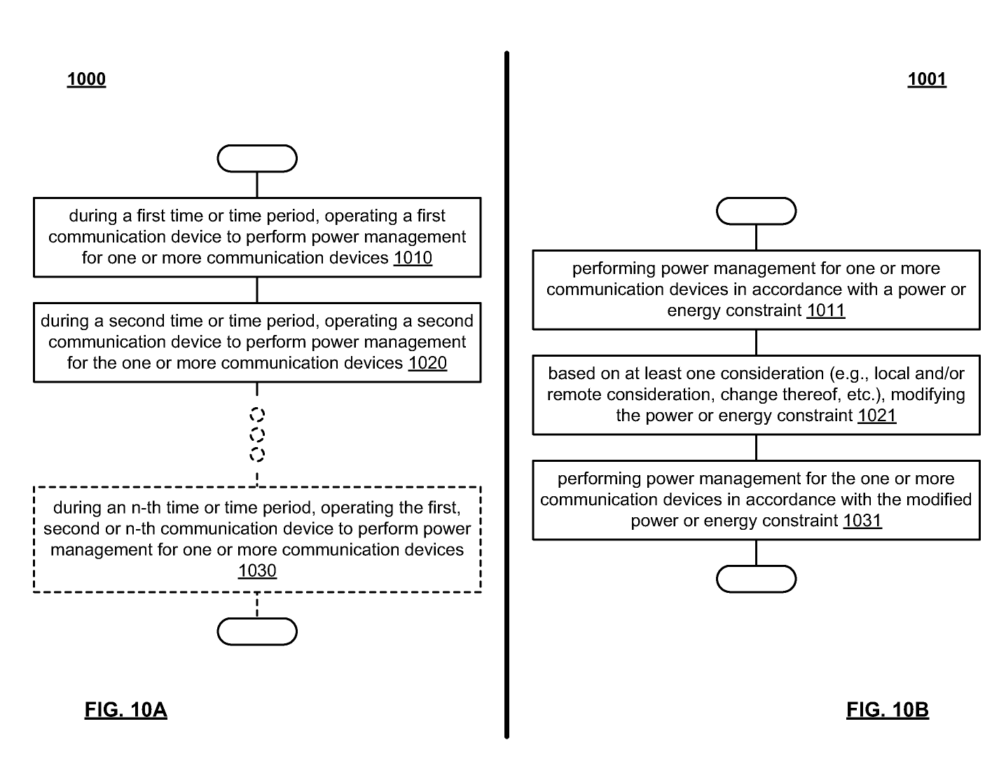

FIG. 8, FIG. 9A, FIG. 9B, FIG. 10A, and FIG. 10B illustrate various embodiments of methods for operating one or more communication devices.

Referring to method 800 of FIG. 8, the method 800 begins by operating the middling device to support communications with a source device and at least one destination device, as shown in a block 810. The method 800 continues by receiving a first media signal from the source device, as shown in a block 820. The method 800 then operates by providing a second media signal, being based on the first media signal, to the at least one destination device, as shown in a block 830. In certain embodiments or situations, the first media signal itself may be provided to the at least one destination device.

The method 800 continues by performing power management for adaptive scalable encoding or transcoding in accordance with a plurality of operational modes based on at least one configuration or operational parameter corresponding to a communication system including the middling device, the source device, and the at least one destination device for compliance with at least one power or energy operational constraint, as shown in a block 840.

Referring to method 900 of FIG. 9A, the method 900 begins by performing power management for one or more communication devices in accordance with a first power or energy constraint during a first time or time period, as shown in a block 910.

The method 900 continues by performing power management for the one or more communication devices in accordance with a second power or energy constraint during a second time or time period, as shown in a block 920.

During an n-th time or time period, the method 900 then operates by performing power management for the one or more communication devices in accordance with an n-th power or energy constraint, as shown in a block 930.

Referring to method 901 of FIG. 9B, the method 901 begins by performing power management for one or more communication devices using a first profile [or combination of profiles] or a first operational parameter [or combination of operational parameters] during a first time or time period, as shown in a block 911.

During a second time or time period, the method 901 then operates by performing power management for one or more communication devices using a second profile [or combination of profiles] or a second operational parameter [or combination of operational parameters], as shown in a block 921.

During an n-th time or time period, the method 901 continues by performing power management for one or more communication devices using an n-th profile [or combination of profiles] or an n-th operational parameter [or combination of operational parameters], as shown in a block 931.

Referring to method 1000 of FIG. 10A, the method 1000 begins by operating a first communication device to perform power management for one or more communication devices during a first time or time period, as shown in a block 1010. During a second time or time period, the method 1000 continues by operating a second communication device to perform power management for the one or more communication devices, as shown in a block 1020.

During an n-th time or time period, the method 1000 then operates by operating the first, second or n-th communication device to perform power management for one or more communication devices, as shown in a block 1030.

Referring to method 1001 of FIG. 10B, the method 1001 begins by performing power management for one or more communication devices in accordance with a power or energy constraint, as shown in a block 1011.

Based on at least one consideration (e.g., local and/or remote consideration, change thereof, etc.), the method 1001 then operates by modifying the power or energy constraint, as shown in a block 1021. The method 1001 continues by performing power management for the one or more communication devices in accordance with the modified power or energy constraint, as shown in a block 1031.

It is also noted that the various operations and functions as described with respect to various methods herein may be performed within a variety of types of communication devices, such as using one or more processors, processing modules, etc. implemented therein, and/or other components therein including one of more baseband processing modules, one or more media access control (MAC) layers, one or more physical layers (PHYs), and/or other components, etc.

In some embodiments, such a processor, circuitry, and/or a processing module, etc. (which may be implemented in the same device or separate devices) can perform such processing to generate signals for communication with other communication devices in accordance with various aspects of the invention, and/or any other operations and functions as described herein, etc. or their respective equivalents. In some embodiments, such processing is performed cooperatively by a first processor, circuitry, and/or a processing module, etc. in a first device, and a second first processor, circuitry, and/or a processing module, etc. within a second device. In other embodiments, such processing is performed wholly by a processor, circuitry, and/or a processing module, etc. within a singular communication device.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “operably coupled to”, “coupled to”, and/or “coupling” includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item. As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

As may also be used herein, the terms “processing module”, “module”, “processing circuit”, and/or “processing unit” (e.g., including various modules and/or circuitries such as may be operative, implemented, and/or for encoding, for decoding, for baseband processing, etc.) may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may have an associated memory and/or an integrated memory element, which may be a single memory device, a plurality of memory devices, and/or embedded circuitry of the processing module, module, processing circuit, and/or processing unit. Such a memory device may be a read-only memory (ROM), random access memory (RAM), volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

The present invention has been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

The present invention may have also been described, at least in part, in terms of one or more embodiments. An embodiment of the present invention is used herein to illustrate the present invention, an aspect thereof, a feature thereof, a concept thereof, and/or an example thereof. A physical embodiment of an apparatus, an article of manufacture, a machine, and/or of a process that embodies the present invention may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of the various embodiments of the present invention. A module includes a functional block that is implemented via hardware to perform one or module functions such as the processing of one or more input signals to produce one or more output signals. The hardware that implements the module may itself operate in conjunction software, and/or firmware. As used herein, a module may contain one or more sub-modules that themselves are modules.

While particular combinations of various functions and features of the present invention have been expressly described herein, other combinations of these features and functions are likewise possible. The present invention is not limited by the particular examples disclosed herein and expressly incorporates these other combinations.

What is claimed is:

1. An apparatus, comprising:
a source device to provide a first media signal;
a middling device, in communication with the source device, to receive the first media signal from the source device and to provide a second media signal, being based on the first media signal; and
a destination device to receive the second media signal from the middling device and to output the second media signal or a third media signal, being based on the second media signal; and wherein:
the middling device to perform power management for adaptive scalable encoding or transcoding in accordance with a plurality of operational modes based on at least one configuration or operational parameter corresponding to a communication system including the middling device, the source device, and the destination device; and
the power management to ensure that at least one of the source device, the middling device, and the destination device to operate in accordance with an energy efficient power or energy recommended practice or standard.

2. The apparatus of claim 1, wherein:
the source device, the middling device, and the destination device cooperatively to perform the power management to ensure that the source device, the middling device, and the destination device to operate in accordance with the energy efficient power or energy recommended practice or standard.

3. The apparatus of claim 1, wherein:
the power management adaptively to partition a plurality of adaptive scalable encoding or transcoding operations among the source device, the middling device, and the destination device;
a first of the plurality of operational modes corresponding a first partition of the plurality of adaptive scalable encoding or transcoding operations among the source device, the middling device, and the destination device; and
a second of the plurality of operational modes corresponding a second partition of the plurality of adaptive scalable encoding or transcoding operations among the source device, the middling device, and the destination device.

4. The apparatus of claim 1, wherein:
the at least one configuration or operational parameter corresponding to at least one of a number of destination devices with which the middling device being in communication, at least one capability of the destination device, at least one operating condition of the destination device, at least one operating condition of the source device, at least one network pathway from the source device to the middling device and to the destination device.

5. The apparatus of claim 1, wherein:
the communication system being corresponding to at least one of a satellite communication system, a wireless communication system, a wired communication system, a fiber-optic communication system, and a mobile communication system.

6. An apparatus, comprising:
a middling device, in communication with a source device and at least one destination device, to receive a first media signal from the source device and to provide a second media signal, being based on the first media signal, to the at least one destination device; and wherein:
the middling device to perform power management for adaptive scalable encoding or transcoding in accordance with a plurality of operational modes based on at least one configuration or operational parameter corresponding to a communication system including the middling device, the source device, and the at least one destination device for compliance with at least one power or energy operational constraint.

7. The apparatus of claim 6, wherein:
the middling device and at least one of the source device and the at least one destination device cooperatively to perform the power management.

8. The apparatus of claim 6, wherein:
the power management to ensure that at least one of the source device, the middling device, and the at least one destination device to operate in accordance with an energy efficient power or energy recommended practice or standard.

9. The apparatus of claim 6, wherein:
a first of the plurality of operational modes corresponding to requiring the middling device to operate in accordance with the energy efficient power or energy recommended practice or standard;
a second of the plurality of operational modes corresponding to requiring the at least one destination device to operate in accordance with the energy efficient power or energy recommended practice or standard; and
a third of the plurality of operational modes corresponding to requiring the middling device and the at least one destination device to operate in accordance with the energy efficient power or energy recommended practice or standard.

10. The apparatus of claim 6, wherein:
the power management adaptively to partition a plurality of adaptive scalable encoding or transcoding operations among the at least one of the source device, the middling device, and the at least one destination device;
a first of the plurality of operational modes corresponding a first partition of the plurality of adaptive scalable encoding or transcoding operations among the source device, the middling device, and the at least one destination device; and
a second of the plurality of operational modes corresponding a second partition of the plurality of adaptive scalable encoding or transcoding operations among the source device, the middling device, and the at least one destination device.

11. The apparatus of claim 6, wherein:
the at least one configuration or operational parameter corresponding to at least one of a number of destination devices with which the middling device being in communication, at least one capability of the at least one destination device, at least one operating condition of the at least one destination device, at least one operating condition of the source device, at least one network pathway from the source device to the middling device and to the at least one destination device.

12. The apparatus of claim 11, wherein:
the at least one operating condition of the at least one destination device corresponding to at least one of a prior or historical operating condition of the at least one destination device, a real-time operating condition of the at least one destination device, and at least one predicted or expected operating condition of the at least one destination device; and
the at least one operating condition of the source device corresponding to at least one of a prior or historical operating condition of the source device, a real-time operating condition of the source device, and at least one predicted or expected operating condition of the source device.

13. The apparatus of claim 6, wherein:
the communication system being corresponding to at least one of a satellite communication system, a wireless communication system, a wired communication system, a fiber-optic communication system, and a mobile communication system.

14. A method for operating a middling device, the method comprising:
operating the middling device to support communications with a source device and at least one destination device;
receiving a first media signal from the source device;
providing a second media signal, being based on the first media signal, to the at least one destination device; and
performing power management for adaptive scalable encoding or transcoding in accordance with a plurality of operational modes based on at least one configuration or operational parameter corresponding to a communication system including the middling device, the source device, and the at least one destination device for compliance with at least one power or energy operational constraint.

15. The method of claim 14, further comprising:
operating the middling device and at least one of the source device and the at least one destination device cooperatively to perform the power management.

16. The method of claim 14, further comprising:
operating the power management to ensure that at least one of the source device, the middling device, and the at least one destination device operating in accordance with an energy efficient power or energy recommended practice or standard.

17. The method of claim 14, wherein:
a first of the plurality of operational modes corresponding to requiring the middling device to operate in accordance with the energy efficient power or energy recommended practice or standard;
a second of the plurality of operational modes corresponding to requiring the at least one destination device to operate in accordance with the energy efficient power or energy recommended practice or standard; and
a third of the plurality of operational modes corresponding to requiring the middling device and the at least one destination device to operate in accordance with the energy efficient power or energy recommended practice or standard.

18. The method of claim 14, further comprising:
operating the power management adaptively to partition a plurality of adaptive scalable encoding or transcoding operations among the at least one of the source device, the middling device, and the at least one destination device; and wherein:
a first of the plurality of operational modes corresponding a first partition of the plurality of adaptive scalable encoding or transcoding operations among the source device, the middling device, and the at least one destination device; and
a second of the plurality of operational modes corresponding a second partition of the plurality of adaptive scalable encoding or transcoding operations among the source device, the middling device, and the at least one destination device.

19. The method of claim 14, wherein:
the at least one configuration or operational parameter corresponding to at least one of a number of destination devices with which the middling device being in communication, at least one capability of the at least one destination device, at least one operating condition of the at least one destination device, at least one operating condition of the source device, at least one network pathway from the source device to the middling device and to the at least one destination device.

20. The method of claim 14, wherein:
the communication system being corresponding to at least one of a satellite communication system, a wireless communication system, a wired communication system, a fiber-optic communication system, and a mobile communication system.
